(19) United States
(12) Patent Application Publication
(10) Pub. No.: US 2004/0155579 A1
(43) Pub. Date: Aug. 12, 2004

(54) Organic electro-luminescent display device and fabrication method thereof

(75) Inventor: Tiao-Hung Hsiao, Fengshan City (TW)

Correspondence Address: Richard P. Berg, Esq., c/o LADAS & PARRY, Suite 2100, 5670 Wilshire Boulevard, Los Angeles, CA, 90036-5679, US

(73) Assignee: AU Optronics Corp.

(21) Appl. No.: 10/751,284

(22) Filed: Dec. 30, 2003

(30) Foreign Application Priority Data
Jan. 10, 2003 (TW) 92100526

(51) Int. Cl. H05B 33/00

(52) U.S. Cl. 313/506

(57) ABSTRACT

An organic electro-luminescent display device of high transparency and a fabrication method thereof. An optic-compensation film of transparent dielectric material is formed on the surface of a glass substrate, in which the transparent nature of the optic-compensation film is not limited to light of a specific wavelength. An anode layer is formed on the optic-compensation film. A laminated body of organic material is formed on the anode layer. A cathode layer is formed on the laminated body.

### BACKGROUND OF THE INVENTION

1. Field of the Invention

The invention relates to an organic electro-luminescent display device, and more particularly to an organic electro-luminescent display device of high transparency and a fabrication method thereof.

2. Description of the Related Art

Organic electro-luminescent display devices have characteristics of thin profile and light weight, and advantages of self luminescence, high luminescent efficiency and low driving voltage. In accordance with organic luminescent materials, the organic electro-luminescent display device can be a molecule-based device or a polymer-based device. The molecule-based device, called an organic light emitting display (OLED), uses dyes or pigments to form an organic luminescent thin film. The polymer-based device, called a polymer light emitting display (PLED), uses conjugated polymers to form an organic luminescent thin film.

FIG. 1 is a sectional diagram of a conventional organic electro-luminescent display device. In a case of OLED, a glass substrate 10 has an anode layer 12, a hole-injecting layer 14, a hole-transporting layer 16, an organic luminescent material layer 18, an electron-transporting layer 20, an electron-injecting layer 22 and a cathode layer 24. The anode layer 12 is indium tin oxide (In₂O₃:Sn, ITO) which has advantages of facile etching, low film-formation temperature and low resistance. When a bias voltage is applied to the OLED, an electron and a hole passing through the electron-transporting layer 20 and the hole-transporting layer 16 respectively enter the organic luminescent material layer 18 to combine as an exciton and then release energy to return to ground state. Particularly, depending on the nature of the organic luminescent material, the released energy presents different colors of light including red light (R), green light (G) and blue light (B). The light is emitted from one end adjacent to the anode layer 12. An arrow 25 in FIG. 1 shows the light-emitting direction.

For a full-color OLED having R, G and B pixel arranged in a specific repeating manner, the pixel dimension should be smaller to achieve a higher resolution. In order to optimize the luminescent efficiency, the R, G, and B luminescent materials are employed to emit three independent radiations by applying different driving voltages. However, the different current densities may vary intensities of the R, G and B lights respectively, affecting color balance. Also, the technology corresponding to the G light technology has been highly developed, but the technologies corresponding to the R and B lights still fail at a commercial level. The luminescent-efficiency ratio of R light to G light and to B light is 1:6:3. FIG. 2 is a curve diagram showing relationships between voltage and luminescent efficiencies of R, G, B lights respectively.

In the conventional organic electro-luminescent display device, transparency of the interface between the glass substrate and the ITO layer varies depending on a wavelength of visible light. FIG. 3 is a curve diagram showing relationship between transparency and wave spectra according to the glass-ITO interface. With regard to a blue light of wavelength smaller than 480 nm, an average transparency of the glass-ITO interface is approximately 85%. With regard to a green light of wavelength between 480 nm and 550 nm, an average transparency of the glass-ITO interface is approximately 87%. With regard to a red light of wavelength larger than 550 nm, an average transparency of the glass-ITO interface is approximately 80%. Since the luminescent efficiency of red light is the lowest in the tricolor display device, the low transparency effect caused by the glass-ITO interface may further decrease the intensity of the red light. Thus, the difference in luminescent efficiency between R, G and B lights becomes greater, and the image properties of the full-color display device are more difficult to control.

### SUMMARY OF THE INVENTION

Accordingly, an object of the invention is to provide an organic electro-luminescent display device and a fabrication method thereof to increase the transparency of red light and decrease the difference in luminescent efficiency between R, G and B lights.

To achieve these and other advantages, the invention provides an organic electro-luminescent display device of high transparency. An optic-compensation film of transparent dielectric material is formed on the surface of a glass substrate, in which the transparent nature of the optic-compensation film is not limited to light of a specific wavelength. An anode layer is formed on the optic-compensation film. A laminated body of organic material is formed on the anode layer. A cathode layer is formed on the laminated body.

### DESCRIPTION OF THE DRAWINGS

For a better understanding of the present invention, reference is made to a detailed description to be read in conjunction with the accompanying drawings, in which:

FIG. 1 is a sectional diagram of an organic electro-luminescent display device according to the prior art;

FIG. 2 is a curve diagram showing relationships between voltage and luminescent efficiencies of R, G, B lights respectively;

FIG. 3 is a curve diagram showing relationship between transparency and wave spectra according to the glass-ITO interface;

FIG. 4 is a sectional diagram of an organic electro-luminescent display device according to the present invention; and

FIG. 5 is a curve diagram showing relationship between transparency and wave spectra according to a glass-SiNx-ITO structure.

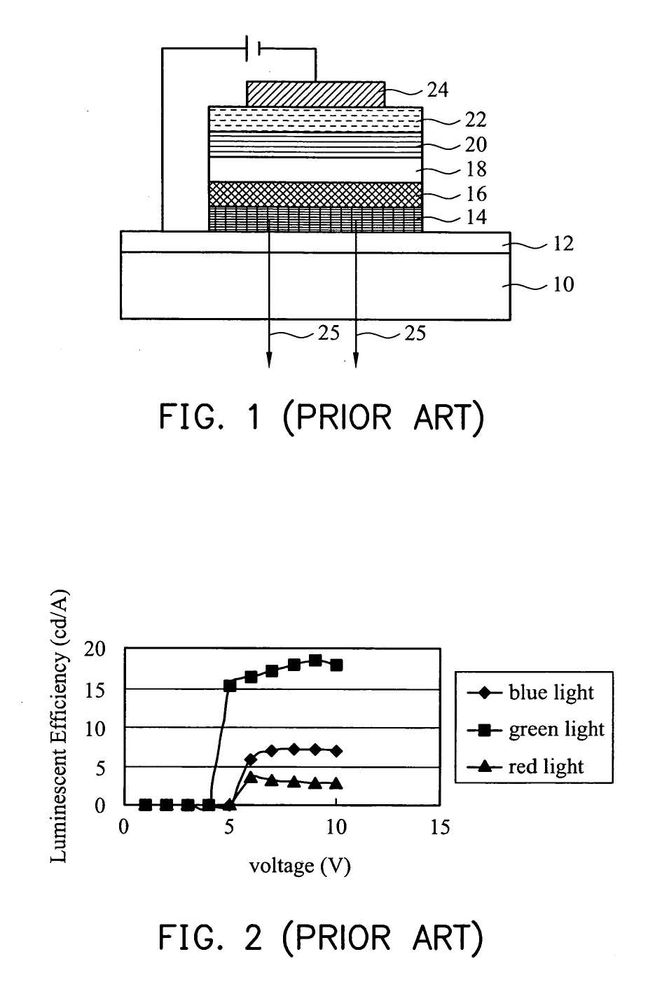

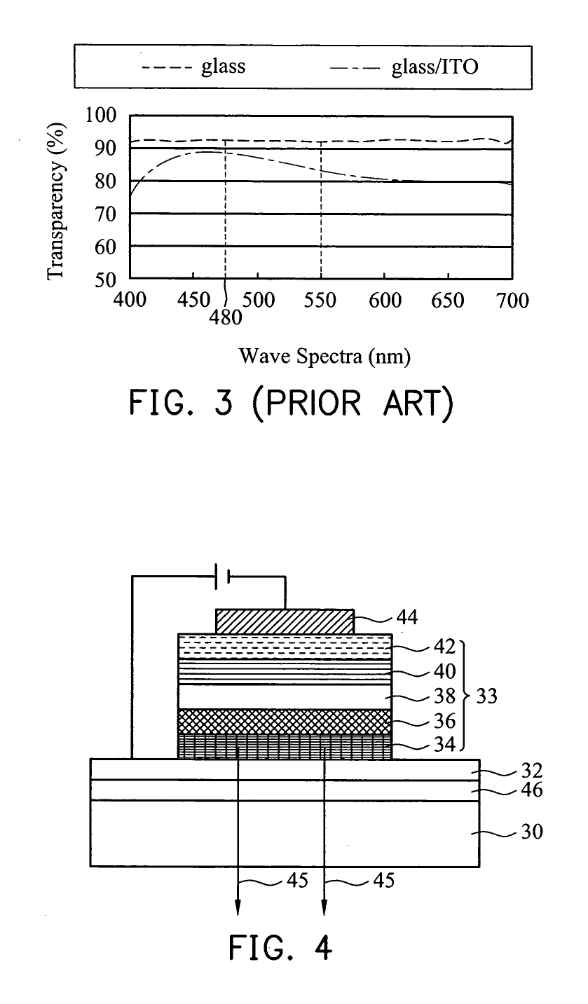

### DETAILED DESCRIPTION OF THE INVENTION

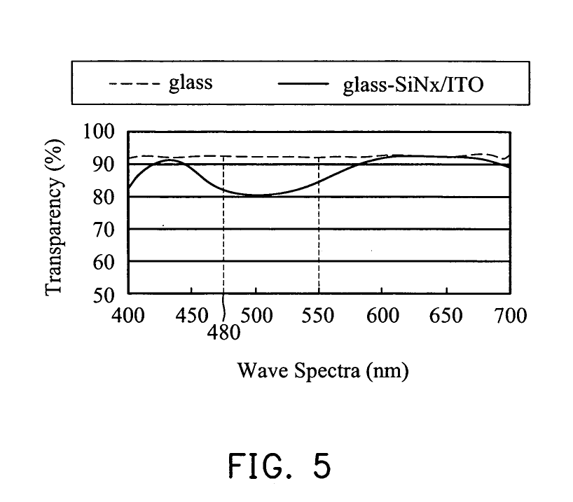

The present invention provides an organic electro-luminescent display device of high transparency and a fabrication method thereof, which can be applied to OLED and PLED devices. A preferred embodiment of the present invention is now described with reference to FIGS. 4 and 5.

FIG. 4 is a sectional diagram of an organic electro-luminescent display device according to the present invention. On a glass substrate 30, an optic-compensation film 46, an anode layer 32, a laminated body 33 and a cathode layer 44 are sequentially patterned. In one application to the OLED device, the laminated body 33 is of molecular-based organic material. In another application to the PLED device, the laminated body 33 is of polymer-based organic material. In the case of the OLED device, the laminated body 33 is constituted by a hole-injecting layer 34, a hole transporting layer 36, an organic luminescent material layer 38, an electron-transporting layer 40 and an electron-injecting layer 42. When a bias voltage is applied to the OLED, an electron and a hole enter the organic luminescent material layer 38 to combine as an exciton and then release energy to return to ground state. Particularly, depending on the nature of the organic luminescent material, the released energy presents different colors of light including red light (R), green light (G) and blue light (B). The light is emitted from one end adjacent to the anode layer 32. An arrow 45 in FIG. 4 shows a light-emitting direction.

The anode layer 32 is ITO. The optic-compensation film 46 is of transparent dielectric material, the nature of light transparency not limited to light of a specific wavelength. Preferably, the optic-compensation film 46 is silicon nitride (SiNₓ) of 100˜3000 Å thickness, in which the optimized thickness is 2000 Å.

FIG. 5 is a curve diagram showing relationship between transparency and wave spectra according to a glass-SiNₓ-ITO structure. In experimental evidence, with regard to a red light of wavelength larger than 550 nm, the transparency of glass is 90%, the transparency of the conventional glass-ITO structure is decreased to 80%, and the transparency of the glass-SiNₓ-ITO structure is increased to approximately 90%. Thus, the optic-compensation film 46 sandwiched between the glass substrate 30 and the anode layer 32 can promote the luminescent efficiency of the red light. Also, with regard to a green light of wavelength between 480 nm and 550 nm, the average transparency of the glass-SiNₓ-ITO structure is decreased from 87% to 80%. This can further decrease the difference in luminescent efficiency between R, G and B lights to improve the tricolor balance.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An organic electro-luminescent display device, comprising:
a glass substrate;
an optic-compensation film of transparent dielectric material formed on the surface of the glass substrate;
an anode layer formed on the optic-compensation film;
a laminated body of organic material formed on the anode layer; and
a cathode layer formed on the laminated body.

2. The organic electro-luminescent display device as claimed in claim 1, wherein the optic-compensation film is silicon nitride (SiNx).

3. The organic electro-luminescent display device as claimed in claim 1, wherein the optic-compensation film is of 100˜3000 Å thickness.

4. The organic electro-luminescent display device as claimed in claim 1, wherein the optic-compensation film promotes transparency of red light to approximately 90%.

5. The organic electro-luminescent display device as claimed in claim 1, wherein the anode layer is ITO.

6. The organic electro-luminescent display device as claimed in claim 1, wherein the laminated body comprises:
a hole-injecting layer formed on the anode layer;
an organic luminescent material layer formed on the hole-injecting layer; and
an electron-injecting layer formed on the organic luminescent material layer.

7. The organic electro-luminescent display device as claimed in claim 1, wherein the organic electro-luminescent display device is an OLED device or a PLED device.

8. A method of forming an organic electro-luminescent display device, comprising:
providing a glass substrate;
forming an optic-compensation film of transparent dielectric material on the surface of the glass substrate, in which the transparent nature of the optic-compensation film is not limited to light of a specific wavelength;
forming an anode layer on the optic-compensation film;
forming a laminated body of organic material on the anode layer; and
forming a cathode layer on the laminated body.

9. The method of forming an organic electro-luminescent display device as claimed in claim 8, wherein the optic-compensation film is silicon nitride (SiNx).

10. The method of forming an organic electro-luminescent display device as claimed in claim 8, wherein the optic-compensation film is of 100˜3000 Å thickness.

11. The method of forming an organic electro-luminescent display device as claimed in claim 8, wherein the optic-compensation film promotes transparency of red light to approximately 90%.

12. The method of forming an organic electro-luminescent display device as claimed in claim 8, wherein the optic-compensation film increases the transparency of red light.

13. The method of forming an organic electro-luminescent display device as claimed in claim 8, wherein the anode layer is ITO.

14. The method of forming an organic electro-luminescent display device as claimed in claim 8, wherein the laminated body comprises:
a hole-injecting layer formed on the anode layer;
an organic luminescent material layer formed on the hole-injecting layer; and
an electron-injecting layer formed on the organic luminescent material layer.

15. The method of forming an organic electro-luminescent display device as claimed in claim 8, wherein the organic electro-luminescent display device is an OLED device or a PLED device.
